(19) United States
(12) Patent Application Publication
(10) Pub. No.: US 2024/0361987 A1
(43) Pub. Date: Oct. 31, 2024

(54) A Method for Training a Neural Network adapted to Generate Random Numbers and the System Thereof

(71) Applicants: Robert Bosch GmbH, Stuttgart (DE); Robert Bosch Engineering and Business Solutions Private Limited, Bangalore (IN)

(72) Inventors: Manojkumar Somabhai Parmar, Ahmedabad, Gujarat (IN); Tanya Motwani, Bangalore, Karnataka (IN); Aithal Himajit, Bangalore, Karnataka (IN)

(21) Appl. No.: 18/692,822

(22) PCT Filed: Aug. 12, 2022
(86) PCT No.: PCT/EP2022/072675

§ 371 Date: Mar. 17, 2024

(30) Foreign Application Priority Data
Sep. 27, 2021 (IN) 2021 4104 3675

(51) Int. Cl. G06F 7/58

(52) U.S. Cl. CPC G06F 7/588; G06F 2207/4824

(57) ABSTRACT

A method for training a neural network adapted to generate random numbers and the system thereof is disclosed. The neural network is configured to generate random numbers identical to the distribution of a quantum random number generator based on the received random noise input using a generative adversarial network framework. The method includes feeding random noise to the generator to generate a noisy output. The noisy output is fed to the discriminator along with a real time output of a quantum random number generator to the discriminator. Further, the discriminator is trained to learn the entropy of the real-time output and distinguish it from the noisy output based on the learned entropy. Finally, the output of the discriminator is fed as feedback to the generator.

### FIELD OF THE INVENTION

The present disclosure relates to a system for generating random numbers and a method for training a neural network adapted to generate random numbers. More specifically, the method for training a neural network adapted to generate random numbers using a generative adversarial network (GAN) framework.

### BACKGROUND OF THE INVENTION

In the upcoming decade, number IoT devices and the distributed system are expected to grow exponentially across industries and domains. All these devices and systems need billions of unique id's for the purposes of identification and security of the devices, transactions and interactions. Identity and security functions are mainly powered by random number generators (RNG). The RNG should essentially provide the requisite entropy or randomness needed for security and identity function to guarantee robust and tamper-proof performance. Random number generator utilizes an entropy source (e.g., a non-deterministic source), along with additional processing function, to generate a random string of numbers. The processing function is used to eradicate the weakness in the source that may result in occurrence of long strings of zeros or ones.

Conventional RNGs did not provide sufficient entropy and therefore, there was a need for better RNG component providing sufficient entropy at a larger scale. Additionally, the current methods of RNGs are not upgradable easily. In case of change, the tight coupling of RNG with algorithm makes it difficult to update/change. The entropy source problem was solved by a Quantum based RNG. Quantum based RNG (QRNG) provides the highest source of entropy. Quantum RNGs exploit elementary quantum mechanics-based phenomena and processes that are fundamentally probabilistic to produce true randomness. As the quantum processes underlying the QRNG are well understood and characterized, their inner working can be clearly modelized and controlled to always produce unpredictable randomness. However, they lack needed scaling in terms of throughput, and are expensive. The present disclosure proposes the use of generative adversarial networks (GAN) as random number generators using the QRNG.

Generative Adversarial Networks (GANs) is a class of generative deep learning frameworks, inspired by game theory and invented in 2014. The framework consists of two neural networks-generator G and discriminator D, involved in a two-player minimax game, such that the generator attempts at creating naturalistic data to deceive the discriminator, while D attempts to separate the fake data (generated by G) from the real ones. Based on the outcome, the generator tries to generate samples which are similar to the original distribution. This method of pitting models against one another is known as adversarial training. It holds that improvements in one component come at the expense of the other ultimately enabling GANs to artificially create high-dimensional new data that appear to be realistic in nature. A trained discriminator can detect irregularities, outliers, aberration and anything out of the ordinary while once a generator can understand the distribution of the sample data, it can create anything related to the data.

Research Paper titled “Pseudo-Random Number Generation using Generative Adversarial Networks”¹ discloses a novel approach for implementation of PRNG by the use of generative adversarial networks (GAN) to train a neural network to behave as a PRNG. It showcases a number of interesting modifications to the standard GAN architecture. The most significant is partially concealing the output of the GAN's generator and training the adversary to discover a mapping from the overt part to the concealed part. The generator therefore learns to produce values the adversary cannot predict, rather than to approximate an explicit reference distribution. However, the disclosed paper doesn't speak of the usage of quantum devices and quantum sources to mimic the RNG. ¹De Bernardi, M., Khouzani, M. H. R. and Malacaria, P., 2018 September. Pseudo-random number generation using generative adversarial networks. In Joint European Conference on Machine Learning and Knowledge Discovery in Databases (pp. 191-200). Springer, Cham.

### BRIEF DESCRIPTION OF THE ACCOMPANYING DRAWINGS

An embodiment of the invention is described with reference to the following accompanying drawings:

FIG. 1 is a block diagram depicting a system (10) for generating random numbers;

FIG. 2 illustrates a method (200) for training a neural network adapted to generate random numbers;

FIG. 3 depicts a framework for training the neural network adapted to generate random numbers;

FIG. 4 shows the architecture details for the generator and discriminator used to carry out method steps (200).

### DETAILED DESCRIPTION OF THE DRAWINGS

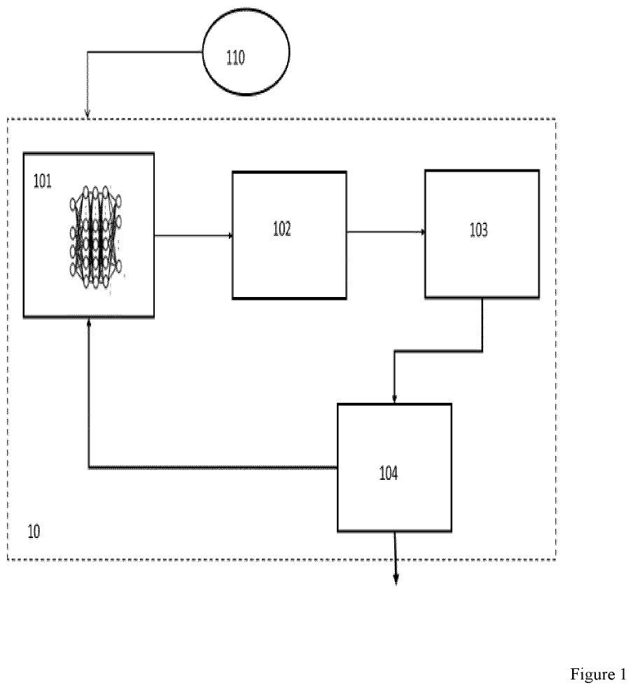

FIG. 1 is a block diagram depicting a system for generating random numbers. The system comprises various modules configured to perform functions as described in the following paragraphs. A module for the purposes of this disclosure can be defined as a self-contained hardware or software component that interacts with the larger system. For example, a neural network (101) mentioned herein after can be a software residing in the system or the cloud or embodied within an electronic chip. Such neural network (101) chips are specialized silicon chips, which incorporate AI technology and are used for machine learning. The system is configured to receive a random noise input from a random noise source (110).

The system for generating random numbers further comprises a pre trained neural network (101), a first evaluation module (102), a second evaluation module (104) and at least a hashing module (103). As explained above, these various modules can either be a software embedded in a single chip or a combination of software and hardware where each module and its functionality is executed by separate independent chips connected to each other to function as the system.

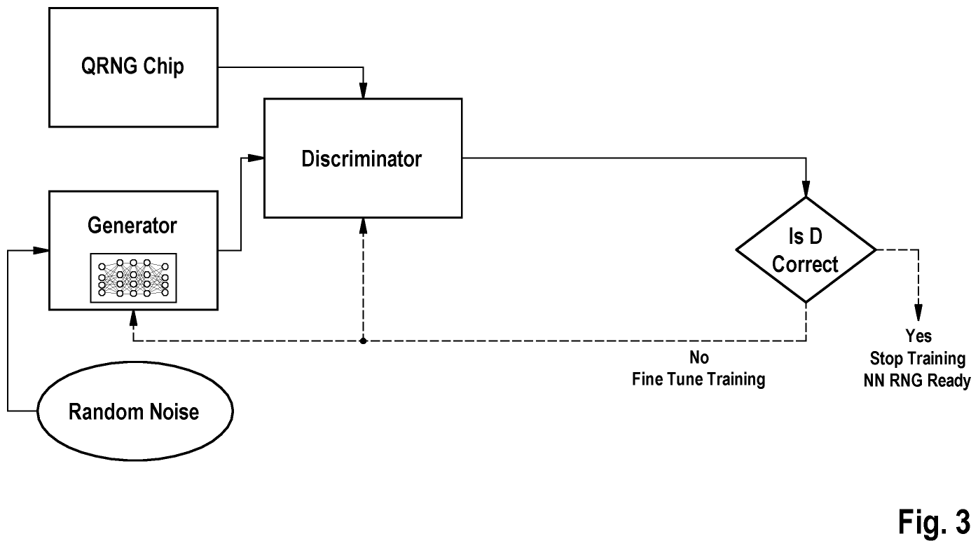

The pre trained neural network (101) is configured to generate random numbers identical to the distribution of a quantum random number generator based on the received random noise input. In one exemplary embodiment of the present disclosure neural network (101) is trained using a generative adversarial network (GAN) framework is accordance with FIG. 3 to mimic the entropy distribution of the random numbers generated by a QRNG. The first evaluation module (102) configured to assess the randomness of generated random numbers. The one-way hashing module (102) configured to operate on the assessed random numbers and generate a final output. The second evaluation module (104) is configured to assess the randomness of the final output. The assessment of the second evaluation function is provided as feedback for the pre-trained neural network (101) or to provide new seed of randomness replacing the random noise source (110).

The first and second evaluation modules run an entropy evaluation function. For example, a AIS20/31 21 standard is considered for evaluation of entropy. For true randomness probability of 1 over a specified length of bit string (e.g. 512) is expected to be within 0.49 to 0.51 (P(1)∈[0.49,0.51]). If probability of 1 lies outside interval [0.475, 0.525] then string is considered to have low entropy and therefore not suitable as random number. In an embodiment of the system, evaluator module (102, 104) discards the bit string if its not suitable for randomness In an embodiment of the system, the one-way hashing module (103)s run one of a SHA 2 cryptographic hash functions.

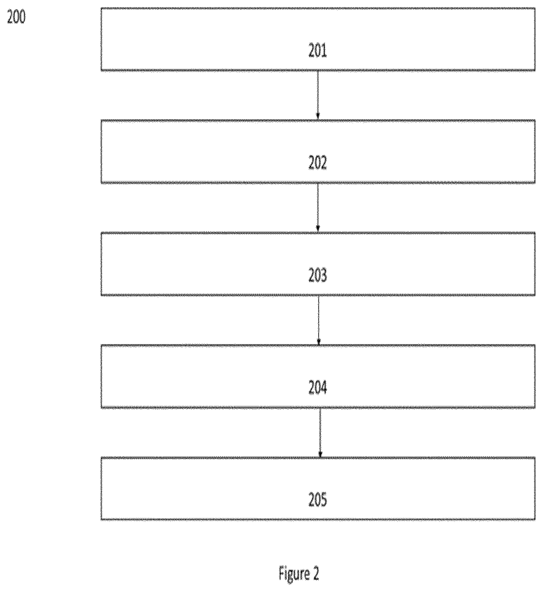

FIG. 2 illustrated method steps for training a neural network (101) adapted to generate random numbers. The method for training a neural network (101) adapted to generate random numbers is carried out using a generative adversarial network (GAN) framework. As explained in the background the GAN framework comprising a generator and a discriminator. The generator attempts to create naturalistic data to deceive the discriminator, while D attempts to separate the fake data (generated by G) from the real ones. Based on the outcome, the generator tries to generate samples which are similar to the original distribution.

FIG. 3 depicts a framework for training the neural network (101) adapted to generate random numbers. The framework uses GAN as described above comprising a generator and a discriminator neural network (101). For the purposes of this disclosure the neural network (101) (i.e. to be trained) acts as the generator. The generator has access to a random noise source with limited entropy. The output of a Quantum based RNG (QRNG) is fed as input or training data to the discriminator. Quantum RNGs are electronic chips that exploit elementary quantum mechanics and processes that are fundamentally probabilistic to produce true randomness.

Method step 201 comprises feeding random noise to the generator to generate a noisy output. In method step 202, this noisy output is fed to the discriminator. Method step 203 comprises feeding real time output of a quantum random number generator (QRNG) to the discriminator. Method step 204 comprises training the discriminator to learn the entropy of the real-time output from QRNG and distinguish it from the noisy output based on the learnt entropy. The discriminator distinguishes the noisy output from the real-time output if the entropy of the noisy output is below a pre-determined threshold. Method step 205 comprises providing the output of the discriminator as feedback to the generator. During the course of training, the generator of the neural network (101) learns to generate an output whose entropy is comparable to the entropy of the real-time output based on the feedback.

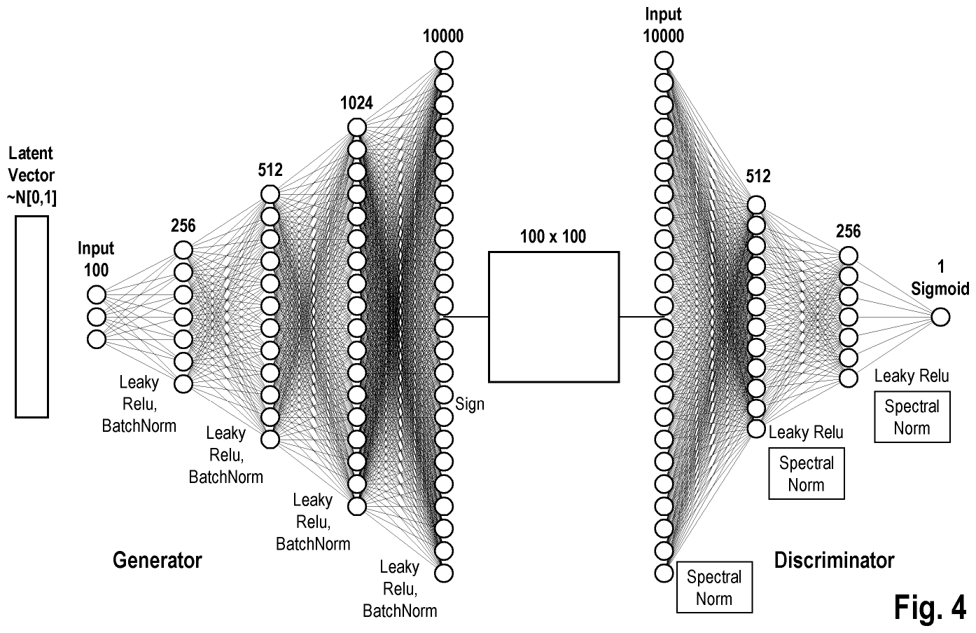

FIG. 4 shows the architecture details for the generator and discriminator used to carry out method steps (200) in accordance with an exemplary embodiment of this disclosure. It should be understood at the outset that, although exemplary embodiments are illustrated in the figures and described below, the present disclosure should in no way be limited to the exemplary implementations and techniques illustrated in the drawings and described below. The discriminator consists of 2 convolutional layers with dimensions shown in the figure. The output layer is a fully connected layer consisting of 1 neuron with sigmoid activation function.

The dimensions of the layers will depend on the size of the input data. The generator (neural network (101) to be trained) has 3 convolutional transpose layers to perform the operation of up sampling. It is well known that a two-layer neural network (101) can learn any function, and therefore, if used will be able to learn the patterns existing in the entropy source (QRNG chip). With these models, we can perform ad-hoc modifications to the generator (neural network (101) to be trained) through training iterations and deal with non-statistical attacks. The model will also be capable of reseeding so that they don't lack entropy after initialization and therefore, no additional effort is needed to monitor the system through security checks. The layers also contain batch normalization for stable training. The activation function used in the last layer is tanh.

This idea to develop the method for training a neural network (101) adapted to generate random numbers and the system thereof helps amplify any low entropy source to provide good quality and high entropy random numbers. Using the neural network (101) trained using method steps (200) in the system (100) gives the required scaling in terms of throughput, which is the drawback for a stand-alone QRNG.

It must be understood that the embodiments explained in the above detailed description are only illustrative and do not limit the scope of this invention. Any modification to the method (200) for training a neural network (101) adapted to generate random numbers and the system (10) thereof are envisaged and form a part of this invention. The scope of this invention is limited only by the claims.

1. A system for generating random numbers, the system configured to receive a random noise input, the system comprising:
a pre trained neural network configured to generate random numbers identical to the distribution of a quantum random number generator based on the received random noise input;
a first evaluation module configured to assess the randomness of generated random numbers using probability distribution within a specified bit string length;
a one-way hashing module configured to operate on the evaluated random numbers and generate a final output; and
a second evaluation module configured to assess the randomness of the final output.

2. The system for generating random numbers as claimed in claim 1, wherein the first and second evaluation module run an entropy evaluation function.

3. The system for generating random numbers as claimed in claim 1, wherein the assessment of the second evaluation function is provided as feedback for the pre-trained neural network.

4. The system for generating random numbers as claimed in claim 1, wherein the output of the second evaluation function is provided as input for the pre-trained neural network.

5. A method for training a neural network adapted to generate random numbers using a generative adversarial network (GAN) framework, the GAN framework comprising a generator and a discriminator, wherein the neural network acts as the generator, the method comprising:
feeding random noise to the generator to generate a noisy output;
feeding the noisy output to the discriminator;
feeding real time output of a quantum random number generator to the discriminator;
training the discriminator to learn the entropy of the real-time output and distinguish it from the noisy output based on the learned entropy; and
providing the output of the discriminator as feedback to the generator.

6. The method for training a neural network adapted to generate random numbers as claimed in claim 5, wherein the discriminator distinguishes the noisy output from the real-time output, if the entropy of the noisy output is below a pre-determined threshold.

7. The method for training a neural network adapted to generate random numbers as claimed in claim 5, wherein the generator learns to generate an output whose entropy is comparable to the entropy of the real-time output based on the feedback.
